(19) United States
(12) Patent Application Publication
(10) Pub. No.: US 2002/0099616 A1
(43) Pub. Date: Jul. 25, 2002

(54) System and method for distributing web content on a network

(76) Inventor: Wim Sweldens, New Providence, NJ (US)

Correspondence Address: Docket Administrator (Rm. 3J-219), Lucent Technologies Inc., 101 Crawfords Corner Road, P.O.Box 3030, Holmdel, NJ, 07733-3030, US

(21) Appl. No.: 09/767,640

(22) Filed: Jan. 23, 2001

(51) Int. Cl. G06F 17/60

(52) U.S. Cl. 705/26

(57) ABSTRACT

Content on the World Wide Web is made available for downloading by distributing it to cache providers. The content provider is a distinct entity from the cache providers and enters into contractual arrangements in order to benefit from the services provided by the cache providers. The contractual arrangements specify certain rights in cache resources that are bought and sold as commodities, exemplarily through a broker or exchange. An exemplary such right is the right to a stated amount of bandwidth, in a stated time interval, for servicing download requests. Responsive to such contractual arrangements, a redirective element such as a DNS server is programmed to redirect, to one or more cache providers, download requests initially addressed to the content provider.

### FIELD OF THE INVENTION

The invention relates to methods for distributing data across a network in response to or in anticipation of requests for file transfers such as download requests. More particularly, the invention relates to the use of cache storage, situated at selected locations, to reduce delay in the servicing of such requests.

### ART BACKGROUND

Users of the World Wide Web are inconvenienced by delays in downloading large files that contain, for example, graphics or videos. Providers and distributors of Web content have addressed this problem by “cacheing,” i.e., by providing copies of popular files in additional servers (“caches”) situated at various locations in the network. Instead of going to the central server, users can request the files from, e.g., local caches situated in relative proximity to the users' own locations. Typically, the user's Web browser initially sends the download request to the central server, but the request is redirected to a local cache.

Redirection of requested files is illustrated in FIG. 1. Content provider 10 has certain files available to be downloaded upon request. Content provider 10 may be any entity that maintains, or is otherwise accessible through, a website. Content provider 10 is identified to users 15, 20, 25 of the World Wide Web by a Uniform Resource Locator (URL), which may be understood in a practical sense as a Web server name of the content provider, plus a filename.

For reasons to be discussed below, content provider 10 stores some or all of its downloadable files at caches, such as caches 30, 35, 40 of the figure, which are conveniently accessible by respective subsets of users. For example, each cache might be located on a different continent, or in a different country. Arrows 45 of the figure represent the transfer of Web content from the content provider to cache.

When a user makes a download request, the user's communication device (typically, a personal computer) initially addresses the download request to the content provider's Web server, as indicated by arrows 50 of the figure. According to well-known principles, such a download request is initially directed to a DNS server such as DNS server 55 of the figure, which is a computational device that may accept instructions provided by the content provider. DNS server 55 translates the Web server name into an IP number, which is a numeric address in the underlying communication network. The IP number identifies a particular cache. As indicated by arrows 60 of the figure, the IP number is returned to the user. The user's communication device then uses the IP number to address the download request to the corresponding cache, as indicated by arrows 65 of the figure. Web content is then downloaded from the selected cache to the user, as indicated by arrows 70 of the figure.

As noted, the DNS server translates the name of the content provider's Web server name into the IP address of a particular cache. Advantageously, the particular cache to be selected is made to depend upon the IP address of the requesting communication device. For example, for a given user, a cache may be selected that is known to lie in close geographical proximity to that user. As indicated by arrow 75 of the figure, the content provider can provide programming to the DNS server that directs the DNS server in its selection of the IP number or numbers to be provided to each user.

The general scheme illustrated in FIG. 1 is merely illustrative, and has several variations and alternatives. For example, one alternative to the use of the DNS server for redirecting Web content is a procedure referred to as “HTML rewrite.” HTML rewrite takes advantage of the fact that files which are provided in response to a download request typically include the addresses of further files that contain objects such as graphics. A server operating according to instructions issued by, e.g. the content provider can rewrite the addresses of such further files so that they will be retrieved from designated cache.

The general scheme illustrated in FIG. 1 can be implemented in various ways. In one type of implementation, the content provider rents cache, which it uses to alleviate the load on its own, central servers by redirecting download requests to the rented cache. In a different type of implementation, an Internet Service Provider (ISP) rents or buys cache, which it uses to reduce the amount of time that the ISP's own subscribers have to wait for their requested downloads to be completed. It should be noted in this regard that because a typical ISP has control over its own network, it can generally carry out redirection, or the equivalent, by methods even simpler than that illustrated in FIG. 1.

### SUMMARY OF THE INVENTION

Although such schemes have proven value in speeding up the servicing of download requests, they do not, in themselves, make it possible to have an open market in cacheing services. Such a market would have several advantages. For example, an open market would afford a user of cache the opportunity to invest only in the amount of cache resources specifically needed at a given time. This is a significant advantage when the volume of download requests is subject to large and sudden fluctuations. As the World Wide Web continues to increase in popularity, such intermittent behavior is likely to increase.

Another advantage of an open market is that it will tend to establish fair pricing for cache resources, based on open information about supply and demand. Another advantage is that in an open market, there are entry opportunities for small-scale as well as large-scale providers of cacheing services. As a consequence, the amount of available cache will tend to rise to meet demand.

Yet another advantage of an open market is that it will permit the buyers and sellers of cacheing services to apply the principles of hedges and futures to reduce the risk of extreme price fluctuations.

I have invented a cacheing scheme flexible enough to support an open market in cacheing services. In my scheme, cache is owned, leased, or otherwise controlled by ISPs or other entities. I refer generically to such an entity as a “cacheing service.” A further entity, which in illustrative embodiments is a commodity exchange, determines the value of cache usage based on supply and demand. For example, commodity exchange transactions might place a value on cache access for honoring download requests for a specified volume in a specified period of time. Such access thus becomes an exchange-traded commodity, and its price is determined by the application of commodity-trading principles to offers of cache access by the cacheing services, and to bids for cache access by the content providers. As a consequence, the content providers can flexibly obtain cache when and where they need it, and the cacheing services can receive a price for the use of their cache that is responsive to current supply and demand.

In specific embodiments of the invention, the redirection of download requests is made pursuant to contracts for cache usage. These contracts are exemplarily made by open commodity trading conducted through a broker or an exchange.

In specific embodiments of the invention, the exchange, or another third party, directly or indirectly receives fees from one or more of the content providers, and directly or indirectly disburses fees to one or more of the cacheing service providers, for the use of cache resources.

The cacheing service provider makes cache resources available to content providers either directly or through intermediaries. A redirective element such as a DNS server is programmed to redirect download requests initially addressed to one or more of the content providers. Each such download request is redirected to cache designated for the content provider to whom the request was initially addressed. In this regard, “cache resources” include storage space, bandwidth as a measure of the volume of data being downloaded per unit time. Such resources, particularly bandwidth, will typically be separately allocable in individual blocks of time. Such a block of time is exemplarily a specified day, week, or month, but could be an even larger or smaller division of time.

### BRIEF DESCRIPTION OF THE DRAWING

FIG. 1 is a simplified block diagram of an illustrative communication network in which cacheing is used to enhance the downloading of Web documents, according to methods of the prior art.

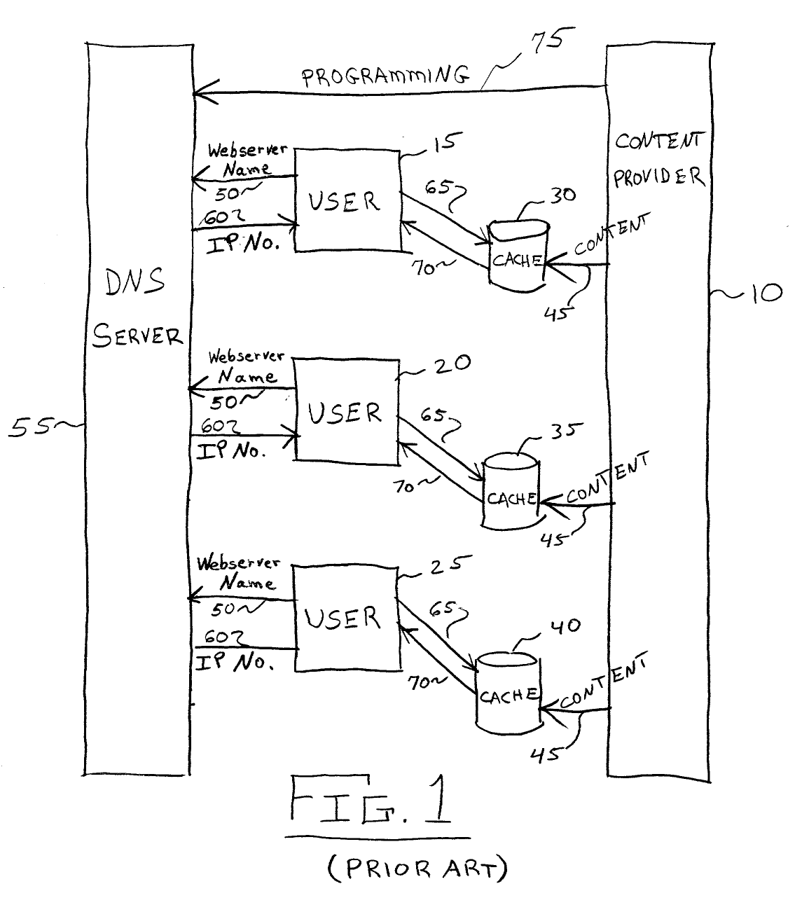

FIG. 2 is a simplified block diagram of an illustrative communication network in which transactions involving cache resources are mediated by a broker, according to the invention in one embodiment. Elements common to FIGS. 1 and 2 are indicated by like reference numerals.

FIG. 3 is a set of graphs of bandwidth versus time, representing an illustrative allocation among three content providers of resources associated with three distinct caches.

FIG. 4 is a conceptual drawing illustrating a billing scheme useful in connection with the present invention in some embodiments.

FIG. 5 is a conceptual drawing illustrating a payment scheme useful in connection with the present invention in some embodiments.

### DETAILED DESCRIPTION

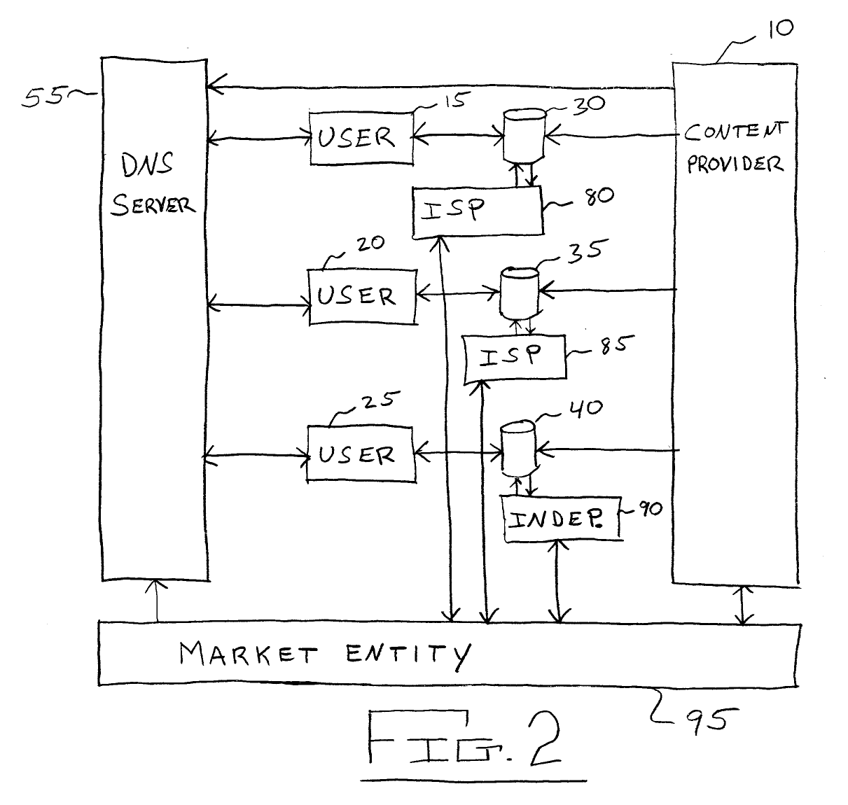

FIG. 2 depicts a network in which each of caches 30, 35, 40 is controlled by a respective cacheing service 80, 85, 90. For purposes of illustration, cacheing services 80 and 85 are identified in the figure as ISPs, and cacheing service 90 is identified as an independent entity. Also shown in the figure is market entity 95.

One example of such a market entity is a commodity exchange for cache resources. Like conventional commodity exchanges, an exchange for cache resources assumes credit risk. That is, the exchange assumes indebtedness for the purchase of cache resources, in the expectation that it will be fully paid back in fees received from content providers, who are the ultimate users of the cache resources. It should be noted that the exchange need not deal directly with the cacheing service providers and the content providers. Instead, there may be one or more layers of intermediaries, who trade in cache resources, interposed between the cacheing services and the exchange, and between the exchange and the content providers.

Market entity 95 may, alternatively, be a broker. As is well known, a broker does not assume credit risk; instead the financial obligations attendant to brokered transactions lie directly between the principal parties.

Purely for pedagogical purposes, and not for limitation, the term “exchange” will be used below to refer to market entity 95. It should be noted, however, that alternate embodiments lie within the scope of the invention, wherein market entity 95 is a broker, or other form of intermediary party.

Each cacheing service sends an offer of cache resources to the exchange. Such an offer specifies the cache resources that are available during specified time intervals. Typically, the offer will include the total amount of storage space that is available for file storage, and, for each specified time interval, the amount of bandwidth that is available for servicing download requests. In this regard, “bandwidth” is a measure of the total volume of data per unit time that can be transferred from the cache into the network. The offer can specify further conditions such as minimum pricing for storage space or bandwidth, a minimum paid-for volume of download requests, and a maximum volume of download requests. Because the major portion of a cacheing service's revenue will typically come from billing for actual download requests serviced, it benefits the cacheing service to bill for a guaranteed minimum volume whether or not the actual requests reach such a volume. Because a surfeit of download requests can interfere with the proper functioning of the cache servers, it benefits the cacheing service to impose an upper limit on the permissible volume of download requests that it receives from a given source.

The cacheing service can also impose policy limitations such as exclusions of certain potential customers, or rules specifying the certain customers are to have access only to certain caches.

The offers placed on the exchange by the cacheing services will typically cover cache usage for one or a few months forward from the current date or a stated future date. However, it will be typical for the offers to be traded continuously, so the current price of cache resources will fluctuate on a daily, and possibly even an hourly, basis.

A bid that a content provider places on the exchange may include a price offered for bandwidth. Bids will typically be for cache resources reserved for discrete blocks of time, beginning at the current time or a stated future time and extending one or a few months into the future. The bidders will typically be able to specify conditions such as maximum acceptable prices and exclusions of selected cacheing services.

As noted, the prices of cache resources will fluctuate in accordance with the principles of commodity trading. Actual matches between cacheing services (as offerors) and content providers (as bidders) can be made automatically or through human activity. One example of trading through human activity is given by the practices of the New York Mercantile Exchange (NYMEX). Although the particular application described there is to trading of oil, the same principles are readily adapted to the trading of cache resources.

Another example of trading through human activity is afforded by OTC brokering of corporate stock. Again, the same principles are readily adapted for trading of cache resources.

By contrast, an example of an automated exchange is Intercontinental Exchange, an electronic commodities exchange based in Atlanta, Ga.

In an illustrative, hypothetical trade of cache resources, a cacheing service provider offers to service download requests during the month of October of the current year. A maximum bandwidth of 100 Mbs is offered at a stated price per Mbs, with a minimum fee based on an average bandwidth usage of 20 Mbs. A credit is offered each time there is more than a 10 ms delay in servicing a download request. The offer is accepted by a content provider. If the transaction is brokered, a contract is made between the cacheing service provider and the content provider. If the transaction is made through an exchange, the exchange makes separate contracts with the respective principal parties. Pursuant to the contract or contracts, download requests initially directed to the content provider's website are redirected to the cacheing service provider. Quality of service is monitored by, e.g., a third party specializing in monitoring services. The redirection will typically be requested by the content provider, but may actually be carried out by a different party, such as the broker or exchange or an agent thereof.

Thus, the outcome of a successful trade is the issuance of a contract between, e.g., the cacheing service and the content provider. The contract will include the pricing terms that the trade was based on. Bandwidth pricing will be based, e.g., on continuous running averages of bandwidth usage or on the ninety-fifth percentile of contiguous five-minute averages.

The contract will also typically spell out penalties to be paid by the content provider for excessive volumes of download requests. The contract will also typically specify quality-of-service (QOS) requirements to be imposed on the cacheing service, and penalties for failure of the cacheing service to honor such requirements. Examples of QOS requirements are maximum tolerable amounts of delay in servicing download requests, as in the preceding example, and maximum tolerable rates of blocking of download requests.

A content provider will generally make its purchases of cache resources in such a way as to drive up efficiency. Efficiency, in this regard, will be a combination of at least two factors: quality of service experienced by users who request downloads, and minimization of the cost to the content provider for assuring such quality of service. Often, the greatest efficiencies will be achieved by distributing Web content over a plurality of distinct cacheing services. Conversely, each cacheing service will often find that it can drive up its own revenue by allocating its available resources among a plurality of content providers.

In practice, such allocations of cache resources will be effectuated by the DNS, which redirects each user's download requests from the content provider (as addressee) to the currently designated cache. This redirection is carried out under programming instructions send by, e.g., the exchange to the DNS server.

It will be clear that the open trading of cache resources is advantageous for the principal parties because it makes it possible for them to manage the risk of large upward or downward fluctuations in the price of cache resources. Such open trading is also advantageous for content providers because it offers the possibility for comparison shopping to obtain the most competitive price. It is also advantageous for content providers because it enables the content provider to adapt to changing demands by its website users by purchasing, at a competitive cost, coverage of download requests directed to specific geographical locations (assuming that cache resources are available at such locations) and for specific blocks of time.

As noted above, additional parties may intermediate between the principal parties and the broker or exchange. In one example, an intermediate party buys cache resources through the broker or exchange, entering into primary contracts. Then, either directly or through further intermediaries, the intermediate party resells the cache resources to content providers, with which the intermediate party enters into secondary contracts.

As noted above, an exemplary commodity to be traded by the broker is the right to fulfull download requests for a specified volume in a specified period of time. One result of the broker's activity will be an allocation of the available cache resources among the various content providers, at specified prices for each content provider's use of each component of the allocated resources. In general, the allocation will be made so as to meet the cacheing services' usage policies and the conditions imposed by the content providers, and within such constraints, to maximize the revenue accruing to the cacheing services.

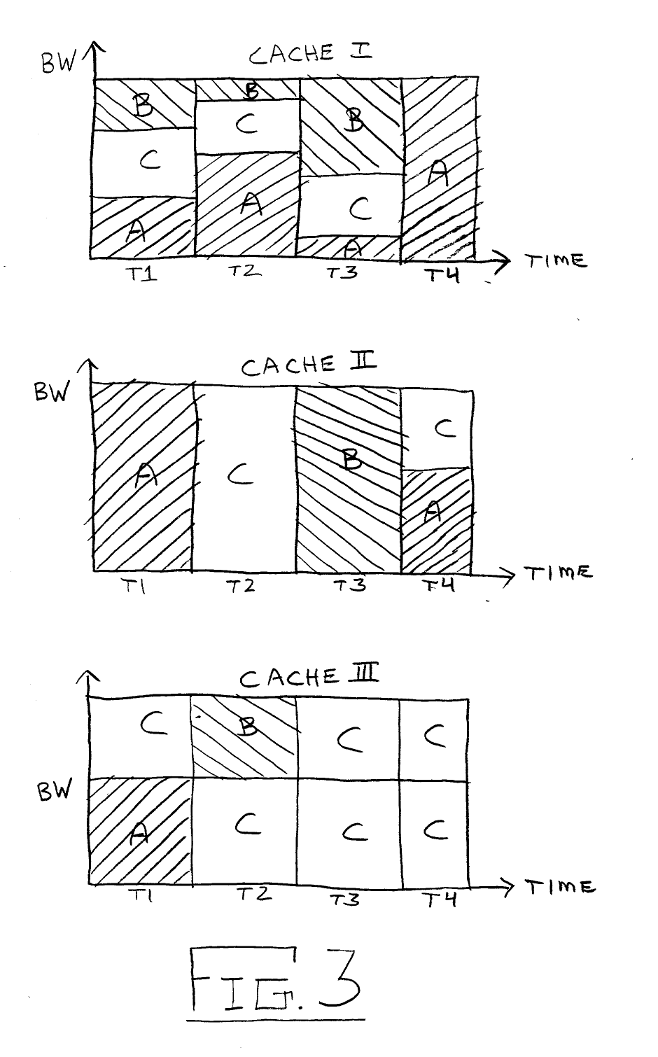

FIG. 3 depicts a hypothetical allocation of cache resources that an exchange might make for an illustrative situation in which resources of three caches, denoted I, II, and III, are available to three content providers, denoted A, B, and C. The allocation is made over four blocks of time, denoted T1, T2, T3, and T4. In the situation illustrated, the total bandwidth available for a given cache in a given time block may be divided one, two, or three ways among the three content providers. Each content provider has a different pattern of usage of each of the three caches. Content provider B, for example, uses Cache I only during T1, T2, and T3, uses Cache II only during T3, and uses Cache III only during T2. Content provider B has exclusive use of Cache II during T3. These patterns will be determined, in part, by competition among the various content providers for cache resources during given time periods, and by the prices the content providers are willing to bid for the use of such resources during such times.

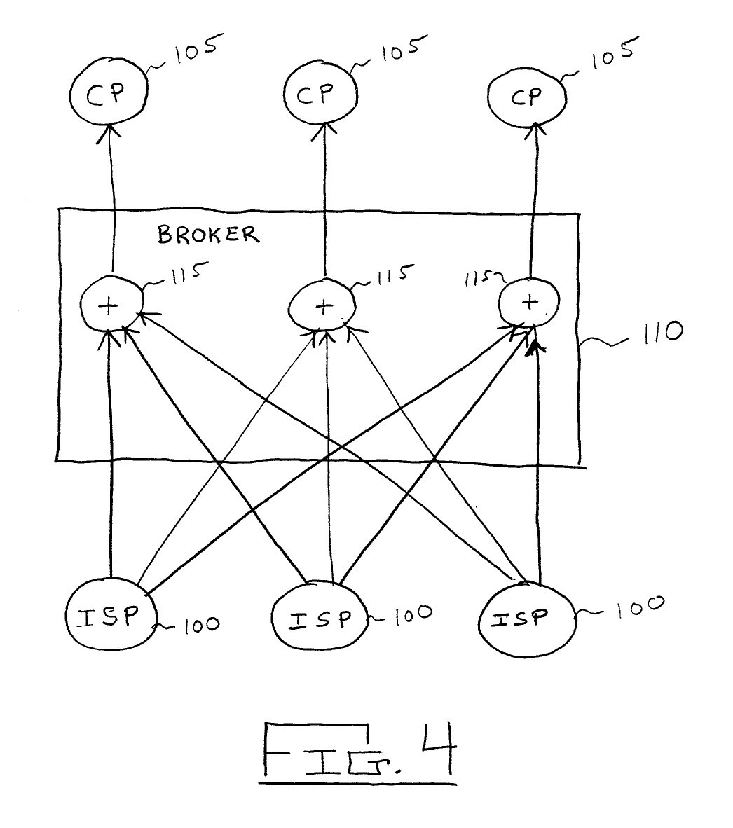

FIG. 4 depicts a convenient billing scheme mediated by an exchange or other market entity. Each ISP 100, or other cacheing service, keeps detailed records of cache usage by each of content providers 105. Each ISP sends a separate bill for each content provider to exchange 110. In turn, exchange 110 compiles all of the charges into one bill for each content provider. In the figure, each summing point 115 represents the compilation of charges for a respective content provider.

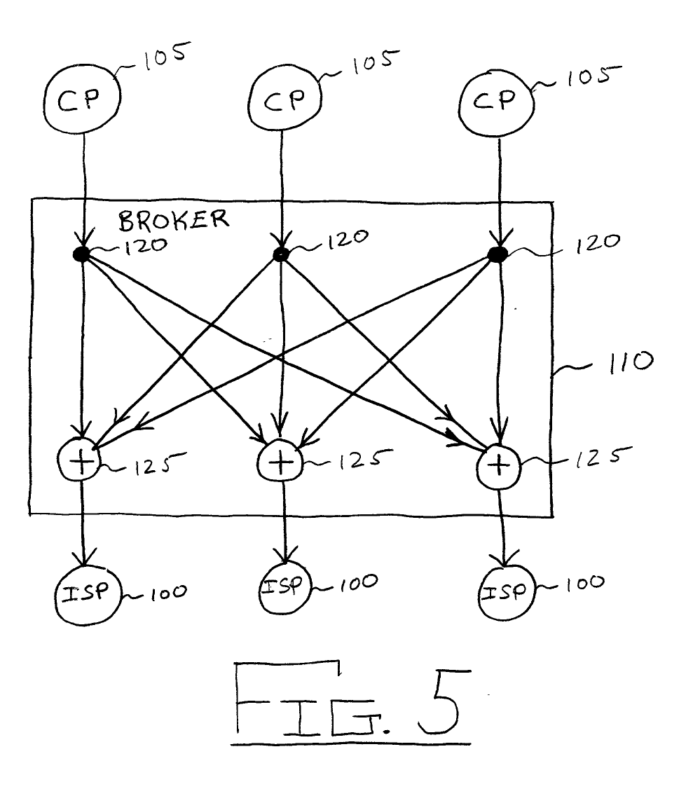

FIG. 5 depicts a convenient payment scheme that is also mediated by the exchange or other market entity. In response to the bills send to the content providers according, e.g., to the scheme of FIG. 4, each content provider 105 sends a payment to exchange 110. As indicated in the figure by distribution points 120, each payment is allocated among the various cacheing services, in an operation that is the inverse of the operation of summing points 115 of FIG. 4. Then, at each of the summing points 125, the payments allocated for a respective cacheing service are compiled into a single payment, which is then sent out to the pertinent cacheing service.

One advantage of the schemes of FIGS. 4 and 5 is a reduction in the total number of contracts. That is, if m content providers dealt individually with n cacheing services, there could be as many as mn separate contracts, each with associated billing and payment. However, by working through an intermediary, the parties reduce the maximum number of contracts to m+n; i.e., m contracts between content providers and the intermediary and n contracts between the cacheing services and the intermediary.

What is claimed is:

1. A method for distributing file content via one or more cache providers, comprising:
a) purchasing one or more commodity contracts, wherein each commodity contract specifies a right to use a stated amount of cache resources belonging to a contracted cache provider during a specified time interval for servicing download requests;
b) making file content accessible to at least one contracted cache provider wherefrom it will be available to users for downloading; and
c) taking action which causes one or more devices to redirect download requests that were initially directed to a content provider, such that the requests will be redirected to said at least one contracted cache provider.

2. The method of claim 1, wherein the method is carried out by a content provider, at least one of the commodity contracts is purchased from an intermediate party distinct from said at least one contracted cache provider, and the method further comprises directing at least one payment to the intermediate party for a service performed by said at least one contracted cache provider.

3. The method of claim 1, wherein at least one of the commodity contracts is purchased through a broker.

4. The method of claim 1, wherein at least one of the commodity contracts is purchased from an exchange, and the method further comprises directing at least one payment to the exchange for a service performed by the pertinent contracted cache provider.

5. The method of claim 1, wherein commodity contracts are purchased from two or more distinct cache providers so as to collectively provide for the servicing of download requests in a desired group of time intervals from a desired group of locations.

6. The method of claim 5, further comprising selecting the two or more distinct cache providers in such a way as to drive down a total cost of the commodity contracts.

7. The method of claim 1, further comprising paying a fee for at least one cache provider to service at least one download request, wherein the fee is based, at least in part, on total download bandwidth.

8. The method of claim 1, wherein the cache resources comprise bandwidth.

9. A method, comprising:
a) selling one or more commodity contracts, wherein each commodity contract specifies an amount of cache resources to be made available during a specified time interval for servicing download requests directed to a content provider's file content;
b) as a result of redirection, receiving one or more download requests that were initially directed to one or more content providers; and servicing one or more of the redirected download requests in accordance with one or more of the commodity contracts.

10. The method of claim 9, wherein at least one of the commodity contracts is sold to an intermediate party distinct from the pertinent content provider, and the method further comprises directing at least one bill to the intermediate party for servicing a download request.

11. The method of claim 9, wherein at least one of the commodity contracts is sold through a broker.

12. The method of claim 9, wherein at least one of the commodity contracts is purchased from an exchange, and the method further comprises directing at least one payment to the exchange for a service performed by the pertinent cache provider.

13. The method of claim 9, wherein commodity contracts are sold to two or more distinct content providers so as to collectively allocate a desired fraction of total cache resources in a desired group of time intervals.

14. The method of claim 9, further comprising sending a bill for the servicing of at least one download request, wherein the amount of the bill is based, at least in part, on total download bandwidth.

15. The method of claim 14, wherein the bill is directed to an intermediate party distinct from the content provider on whose behalf the download request is serviced.

16. The method of claim 9, wherein the cache resources comprise bandwidth.

17. A method, comprising:
a) purchasing at least one commodity contract from each of one or more cache providers, wherein each commodity contract specifies a right to use a stated amount of cache resources belonging to a contracted cache provider during a specified time interval for servicing download requests; and
b) reselling at least one said commodity contract for ultimate acquisition by a content provider.

18. The method of claim 17, wherein the purchase and the resale of the commodity contract are made directly from a cache provider and to a content provider, respectively.

19. The method of claim 17, wherein the purchase of the commodity contract is made from an intermediate party, or the resale of the commodity contract is made to an intermediate party, and the intermediate party is distinct from the pertinent cache provider and the pertinent content provider.

20. The method of claim 19, wherein the purchase of the commodity contract is made from an intermediate party, and the resale of the commodity contract is made to an intermediate party, and both said intermediate parties are distinct from the pertinent cache provider and the pertinent content provider.

21. The method of claim 17, wherein two or more commodity contracts are purchased from a single cache provider and resold to a plurality of content providers.

22. The method of claim 17, wherein commodity contracts are purchased from two or more distinct cache providers and resold to a single content provider.

23. The method of claim 17, wherein said purchasing and reselling steps are carried out by a commodity exchange.

24. The method of claim 17, further comprising: providing at least one payment, ultimately to be directed to a cache provider, for the servicing of a download request by the cache provider; and providing at least one bill, ultimately to be directed to a content provider, for the servicing of the download request.

25. The method of claim 17, further comprising, responsive to the purchase and resale of at least one said commodity contract, taking action which causes one or more devices to redirect download requests that were initially directed to the content provider, such that the requests will be directed to one or more of the cache providers.

26. The method of claim 17, wherein the cache resources comprise bandwidth.
